(19) United States
(12) Patent Application Publication
(10) Pub. No.: US 2003/0139929 A1
(43) Pub. Date: Jul. 24, 2003

(54) Data transmission system and method for DSR application over GPRS

(76) Inventors: Liang He, Shanghai (CN); XiaoGang Zhu, Shanghai (CN); Cheng Zhang, Shanghai (CN); ChuanQuan Xie, Shanghai (CN); Xun Wang, Shanghai (CN)

Correspondence Address: James H. Salter, BLAKELY, SOKOLOFF, TAYLOR & ZAFMAN LLP, 7th Floor, 12400 Wilshire Boulevard, Los Angeles, CA, 90025, US

(21) Appl. No.: 10/057,161

(22) Filed: Jan. 24, 2002

(51) Int. Cl. G10L 21/00

(52) U.S. Cl. 704/270.1

(57) ABSTRACT

A DSR system and method is disclosed. A DSR system comprising: a client to send connection requests, receive displayable content, and transmit speech feature data to a server; a gateway coupled between the client and the server to support data communication between the client and the server; and a server to receive the speech feature data, perform speech recognition on the speech feature data, and transmit displayable content to the client.

### RELATED APPLICATION

This application is related to co-pending patent application Ser. No. ______ entitled, “The Architecture for DSR Client and Server Development Platform”, filed Jan. 24, 2002, which application is assigned to the assignee of the present application.

1. Field of the Invention

This application generally relates to distributed speech recognition (DSR), particularly to a data transmission system and method for a Distributed Speech Recognition (DSR) application.

2. Background of the Invention

With the growth of the Internet technology and speech recognition technology, both speech researchers and computer software engineers have been putting a great deal of effort into integrating speech functions with Internet applications. Due to the ease-of-use nature, speech recognition technology that provides a convenient input methodology for accessing mobile Internet services is becoming more and more important for mobile communication systems.

There are alternative architectures, in the art, for speech recognition. The first is a server-only processing strategy wherein the speech recognition process is performed only at the server side. In this architecture, the client just records the user's voice and transmits the recorded voice to the server for processing. The second alternative architecture is a client-only processing strategy wherein the recognition process is performed at the client side and only the result of the speech recognition is transmitted to the server. The third conventional approach is a client-server processing strategy wherein feature extraction is performed at the client side. Speech feature extraction requires only a small part of the computation load needed for the entire procedure of speech recognition. The extracted speech features are transmitted from the client to the server and then speech recognition is performed at the server side based on the extracted speech features.

The disadvantage of the first approach is that a high-quality and high-bandwidth connection between the client and server is required to support the transmission of voice data. In a typical implementation, the recognition performance degrades for data rates below 32 kb/s. The second approach has limitations too, because the complexity of medium and large vocabulary speech recognition systems are beyond the memory and computational resources of most small portable computing devices. The third approach overcomes the disadvantages of the preceding two approaches in that less data is transmitted between client and server than the first approach, and less computational burden is placed on the client than the second approach.

The Distributed Speech Recognition (DSR) system, standardized by ETSI, is based on the third approach identified above, which overcomes these problems by using a low bit rate data channel to send a parameterized representation of the speech from client to server, which is suitable for recognition by the server. The speech processing is thus distributed between the client terminal and the network. The client terminal performs the speech feature parameter extraction, or the front-end processing of the speech recognition system. These extracted speech features are transmitted over a data channel to a remote “back-end” recognizer.

In spite of the advantages of the conventional DSR application system, the system still has particular requirements of data transmission. As the speech features transmitted from DSR client to DSR server are packet data not a voice stream, a low bit error rate is required. For the interaction (characteristic of conversation) between the DSR server and the DSR client, the typical DSR application system is sensitive to network transmission delay. As a result, the typical DSR application system has special Quality of Service (QoS) requirements due to its speech-like and data-like characteristics. Moreover, because of the complexity of the network between the DSR server, DSR clients and the Web server with which the DSR application system operates, data transmission quality, latency, and stability are very important issues in a typical DSR application system.

Meanwhile, as a packet-oriented extension of GSM, well-known GPRS (General Packet Radio Services) can support IP protocol and QoS to provide a reliable wireless IP packet transmission system with high efficiency.

### BRIEF DESCRIPTION OF THE DRAWINGS

The features of the invention will be more fully understood by reference to the accompanying drawings, in which:

FIG. 1 is an illustrative diagram that shows a DSR application system over a GPRS wireless network and the Internet in accordance with an embodiment of the present invention;

FIG. 2 is a block diagram that depicts an embodiment of a data transmission system for a DSR application in accordance with an embodiment of the present invention;

FIG. 3 is a block diagram that depicts a DSR client wrapper of a data transmission system for a DSR application in accordance with an embodiment of the present invention;

FIG. 4 is a block diagram that depicts a DSR server wrapper of a data transmission system for a DSR application in accordance with an embodiment of the present invention;

FIG. 5 is a flow chart that depicts a method for sending DSR data from a DSR client to a DSR server of a DSR application system, in accordance with an embodiment of the present invention;

FIG. 6 is a flow chart that depicts a method for receiving DSR data at a DSR server of a DSR application system, in accordance with an embodiment of the present invention.

### DETAILED DESCRIPTION

The structure, operation, advantages, and features of the present invention will become apparent in the following detailed description by reference to the accompanying drawings.

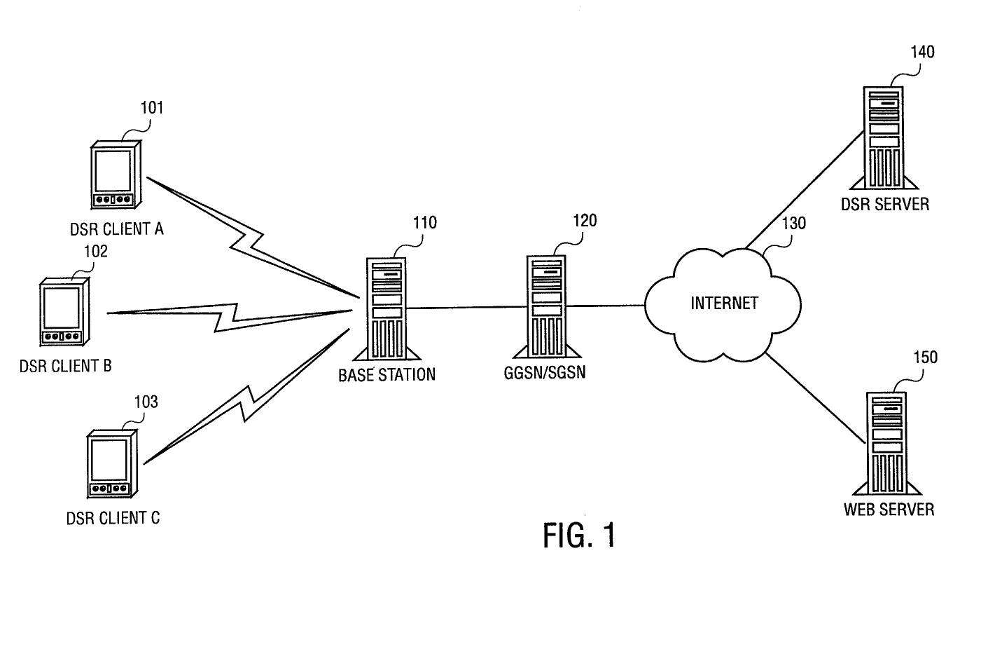

A DSR application system is an integration of Distributed Speech Recognition and World-Wide Web (WWW). As shown in FIG. 1, which is an illustrative diagram that shows a DSR application system over a GPRS wireless network and the Internet in accordance with an embodiment of the present invention, the DSR application system comprises a plurality of DSR clients (101-103), a DSR server (140) and a Web server (150) connecting to the Internet (130). There is also a base station (110) and a Gateway GPRS Support Node/Serving GPRS Support Node (GGSN/SGSN) (120) between the DSR clients (101-103) and the Internet (130).

In this embodiment, the DSR clients (101-103) are mobile terminals of a GPRS wireless network, such as mobile phones or other mobile computing devices with GPRS support. As well known in the art, GPRS (General Packet Radio Services) is a packet-oriented extension of GSM, which supports the IP protocol and QoS. GGSN (GPRS Gateway Support Node) and SGSN (Serving GPRS Support Node) are used to support wireless/wired interconnection.

The DSR application system generally operates in the manner described below:

1) one of the DSR clients (e.g. DSR client A (101)) first initiates a DSR session with the DSR server (140) by sending a request and preference information (such as characteristics of a user's speech and voice input device) to the DSR server (140);

2) upon the receipt of the request, the DSR server (140) sends a DSR Extensible Markup Language (DSRML) request to the Web server (150), optionally with the help of a DSR Domain Name Service (DNS) (not shown in FIG. 1), and the Web server (150) sends back related DSRML documents;

3) after receiving the DSRML documents, the DSR server (140) parses the documents and compiles all the grammars that the speech recognition engine needs;

4) the DSR server (140) generates display content that is organized as a document comprising information cards. DSR server (140) sends the displayable information cards to the DSR client (101) and waits for user speech feature extraction data from the DSR client (101);

5) upon receipt of the displayable information card document, the DSR client (101) displays a relevant card of the document and triggers the speech Front-End engine to wait for the user utterance input;

6) when a user utterance is received, the DSR client (101) performs a Front-End speech algorithm, extracts speech features, packs the feature extraction data and then sends the feature extraction packets to the DSR server (140);

7) after all the speech feature extraction data from the DSR client (101) is received, the DSR server (140) starts to perform speech recognition on the feature extraction data;

8) if the speech recognition result means that the DSR client (101) needs to display another display card from the displayable information card document, the DSR server (140) sends an event notification and a relative displayable information card identifier (ID) to the DSR client (101) to instruct the DSR client (101) to display the corresponding card; after the DSR client (101) displays the identified card, the speech capture operation will be repeated from the step of waiting for a user utterance;

9) if the speech recognition is unsuccessful or the utterance is not decipherable, the DSR server (140) sends a corresponding event notification to the DSR client (101) and the DSR client displays an error indication;

10) if the speech recognition result means that the DSR client (101) needs to display a new document, the DSR server (140) sends a DSRML request to Web server (150), and after receiving the requested DSRML document, the server parsing operation will be repeated from the step of parsing and compiling the DSRML document.

In the above description, DSRML (DSR Extensible Markup Language) is a specialized markup language based on conventional XML and is defined and customized for the DSR application system.

It should be appreciated that the above description of the operation of a DSR application system is based on a particular embodiment and provided for the purpose of illustration. There are many variants of the DSR application system of the present invention. For example, there could be more DSR clients and more Web servers or DSR servers than those shown in FIG. 1. Further, the networks could be different than those shown.

As mentioned above, in a DSR application system speech feature extraction is performed by the Front-End engine of the DSR client and speech recognition is performed by the DSR server. It is well known by those of ordinary skill in the art that speech recognition needs only a small part of the information that the speech signal carries. The representation of the speech signal used for recognition concentrates on the part of the signal that is related to the vocal-tract shape. So the data traffic generated by transmitting speech information is greatly reduced. But, all these operations (user utterance inputting, extracting speech features, transmitting the features to the DSR server, recognizing, retrieving DSRML, sending corresponding documents or events back to the DSR client and display feedback to the user) should be performed in a user tolerant time frame.

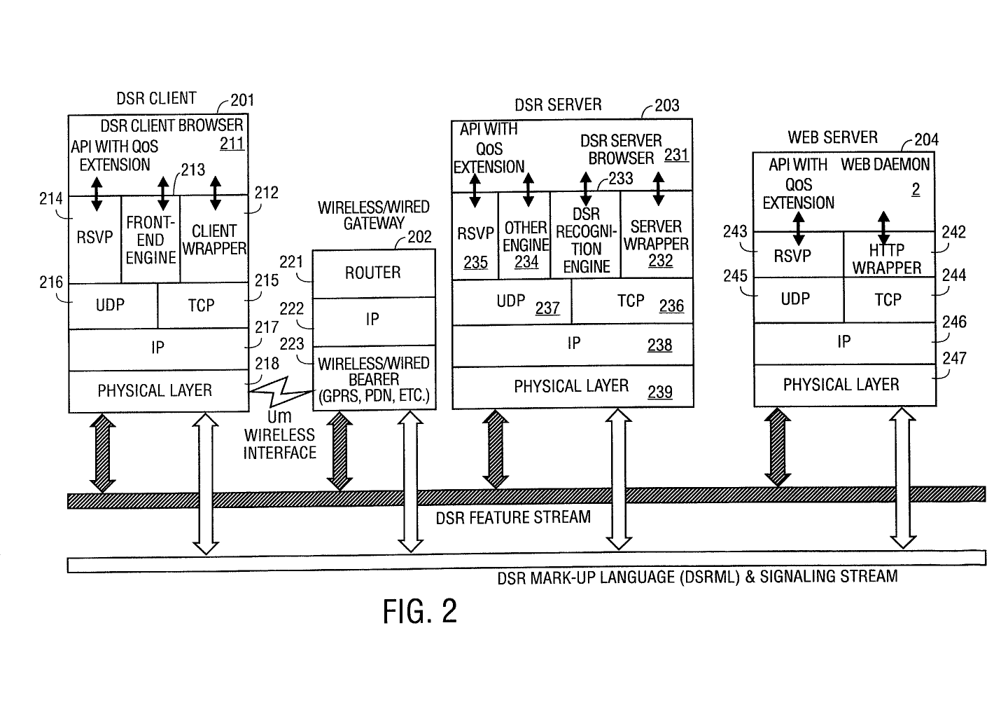

FIG. 2 is a block diagram that depicts the components of a DSR application and the data transmission system thereof in accordance with one embodiment of the present invention. The DSR application system in FIG. 2 includes a DSR client (201), a DSR server (203), a Web server (204) and a wireless/wired gateway (202).

As shown in FIG. 2, the DSR client (201) comprises a DSR client browser (211) for allocating the tasks to the components of front-end engine (213) and client wrapper (212), displaying content in the client's display screen and originating QoS requests. An RSVP module (214) supports RSVP protocol and QoS functionalities, such as a packet classifier, admission control, a packet scheduler and the like. A front-end engine (213) is provided for reducing noise, extracting speech features, and providing a speech feature extraction stream to the DSR client browser (211). A client wrapper (212) is provided for sending connection requests, receiving DSRML document contents, transmitting speech feature extraction data and handling events for synchronization. Additional components such as the UDP (216), TCP (215), and IP (217) modules and physical layer (218) are provided for supporting basic underlying network protocols.

The DSR server (203) comprises a DSR server browser (231) for interpreting DSRML documents, allocating the tasks to other processing engines, sending display contents back to the DSR client after other processing engines finish their tasks and for originating QoS requests. RSVP (235) module for supports RSVP protocol and QoS functionalities. Other processing engines (234) for control transmission, balancing workload and generating client content, etc., which is described in the related patent application referenced above. A DSR recognition engine (233) performs speech recognition. A server wrapper (232) receives speech feature extraction data, transmits and wraps DSRML content, and handles events for synchronization. Other server components, such as UDP (237), TCP (236), IP module (238), and physical layer (239) for support standard basic underlying network protocols.

The Web server (204) comprises a web daemon (241) for processing requests from the DSR server browser (231), for producing DSRML documents in reply, and for originating QoS requests. RSVP module (243) for supports RSVP protocol and QoS functionalities. An HTTP wrapper (242) is provided for encapsulating and delivering HTTP application data using HTTP protocol. Other Web server components, such as UDP (245), TCP (244), IP module (246), and physical layer (247) support basic underlying network protocols.

Wireless/wired gateway (202) supports wireless and wired communication between DSR clients and a wireless access network, such as SGSN and GGSN.

The DSR data transmission system is composed of client (201) side components including the client wrapper (212), the RSVP module (214), the lower layer modules including UDP (216), TCP (215), IP (217), and the physical layer (218). Server (203) side components including the server wrapper (232), the RSVP module (235), the lower layer modules including UDP (237), TCP (236), IP (238) and the physical layer (239). Additional components of the DSR data transmission system include and the wireless/wired gateway (202).

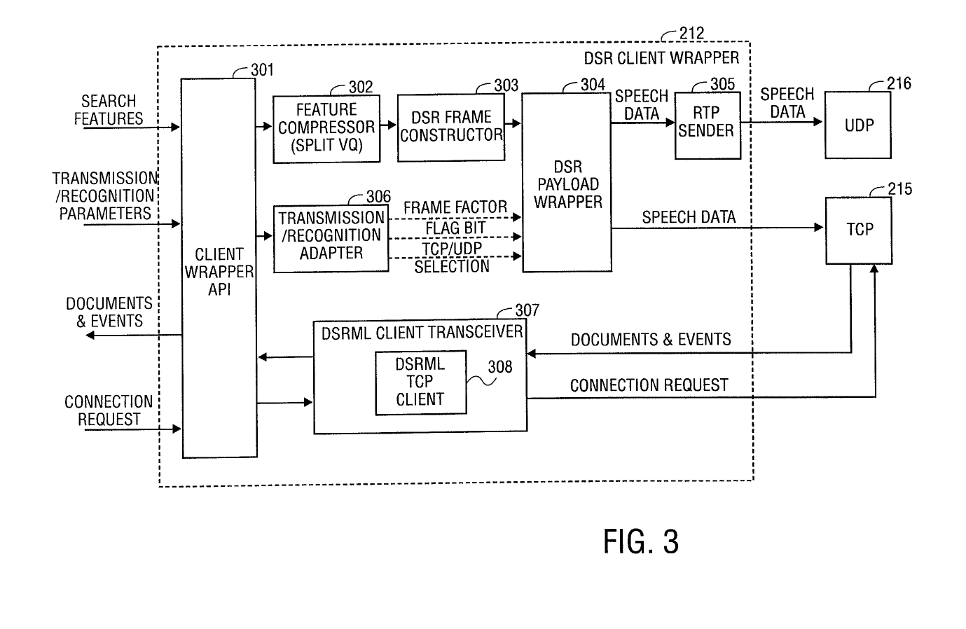

FIG. 3 is a block diagram that depicts a DSR client wrapper (212) of the DSR data transmission system in accordance with one embodiment of the present invention. As shown in FIG. 3, the client wrapper (212) is composed of a client wrapper API (301) for interfacing between the client wrapper (212) and outside modules; a feature compressor (302) for compressing speech feature extraction data, with which a vector compression algorithm could be utilized; a DSR frame constructor (303) for constructing DSR frames; a transmission/recognition adapter (306) for adjusting transmission control conditions of the DSR payload wrapper (304) and to control flag bits needed for recognition according to transmission/recognition parameters; a DSR payload wrapper (304) for constructing DSR payload data packets, for adding flag bits to the DSR packets, and for passing the DSR payload to corresponding protocol stacks according to a TCP/UDP selection; an RTP sender (305) for sending data using RTP through UDP/IP protocol stacks, which includes a buffer (not shown in FIG. 3) for storing the packets, which have been sent out but not acknowledged by the DSR server; a DSRML client transceiver (307) for receiving DSRML data and for sending an initial connection request to the DSR Server, which also includes a DSRML TCP client (308) for implementing the function of TCP client.

The control parameters mentioned above are used to control corresponding flexible options of the speech feature extraction transmission including:

1) Frame factor: determines how many frames should be encapsulated into one DSR payload packet;

2) TCP/UDP selection: indicates whether the speech features should be transmitted using TCP protocol or using UDP protocol;

3) Flag bits: indicate the end of current speech input, the current sample rate, and the front-end type in each DSR payload packet.

The speech features are received by client wrapper API (301) from DSR client browser (211) and sent to feature compressor (302) where they are compressed using a conventional compression algorithm, such as vector quantization (VQ) that is well known in the art. The compressed speech features are then sent to DSR frame constructor (303). DSR frame constructor (303) packages the compressed speech features into a DSR frame according to a DSR frame format that is standardized by ETSI. Then, DSR payload wrapper (304) receives the compressed speech feature data in a frame format, constructs DSR payload packets comprising a plurality of DSR frames, and adds flag bits to the DSR packets.

As the speech features are received from DSR client browser (211), transmission/recognition parameters are also received by the client wrapper API (301) and sent to transmission/recognition adapter (306). Transmission/recognition adapter (306) adjusts transmission control conditions of the DSR payload wrapper (304) and controls flag bits needed for recognition according to the received transmission/recognition parameters. Therefore, DSR payload wrapper (304) sends the prepared DSR packets to RTP sender (305) or TCP module (215) according to the TCP/UDP selection in the transmission/recognition parameters. If the TCP/UDP selection is TCP, DSR payload wrapper (304) sends the DSR packets to TCP module (215); if the TCP/UDP selection is UDP, DSR payload wrapper (304) sends the DSR packets to RTP sender (305), and RTP sender (305) then sends the DSR packets using RTP/UDP/IP protocol stacks. RTP sender (305) has a buffer (not shown in FIG. 3) that is used to store the DSR packets, which have been sent out but not acknowledged by DSR server (203).

GPRS performance is more optimum for large packet sizes, because of transmission overhead becoming increasingly significant as the packet size decreases, as known in the art. The GPRS system can handle greater input loads when transferring larger packets before the saturation point at which transfer delay increases dramatically. This means more input can be served with reasonable latency.

Therefore, in order to reduce DSR transmission overhead over GPRS, we increase the number of frames included in a DSR payload packet in our DSR application. Two bytes are also allocated in each DSR payload packet to indicate the end of current speech input, the number of frames included in the current packet, the current sample rate and the front-end type. However, an increasing number of frames in a packet creates a risk of the failure of the speech recognition if packet loss or corruption occurs during the transmission. Thus, reliable delivery of DSR speech feature data is of a high priority for DSR transmission over GPRS.

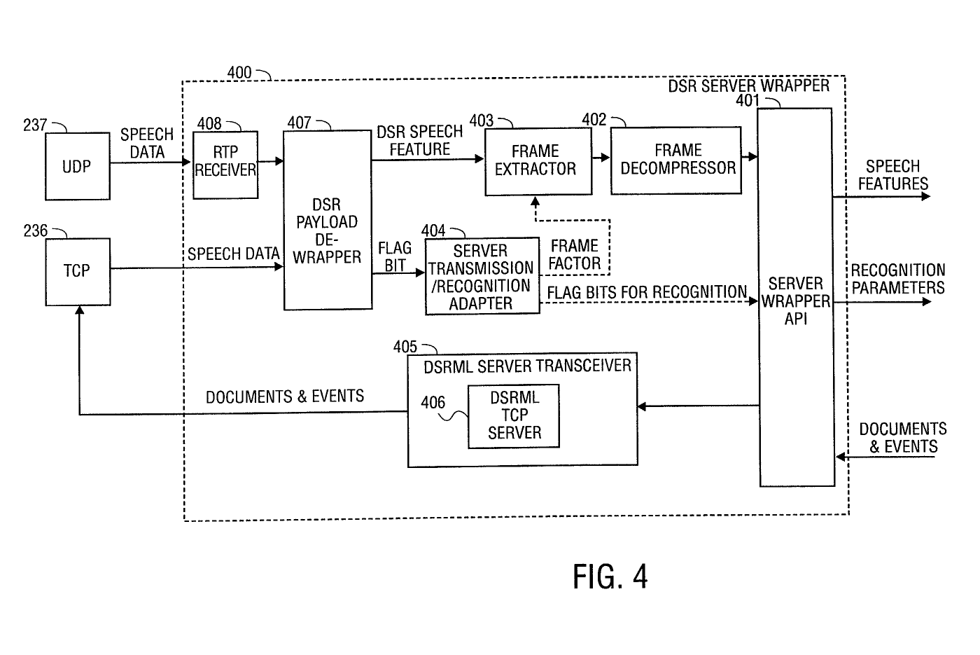

FIG. 4 is a block diagram that depicts a DSR server wrapper (400) of the DSR data transmission system in accordance with one embodiment of the present invention. As shown in FIG. 4, the server wrapper (400) is composed of an RTP receiver (408) for receiving packets using RTP through UDP/IP protocol stacks and for extracting DSR payload from the received packets; a DSR payload de-wrapper (407) for separating DSR speech feature extraction data from the transmission/recognition parameters; a DSR frame extractor (403) for extracting DSR frames; a feature de-compressor (402) for de-compressing speech feature extraction data; a server transmission/recognition adapter (404) for controlling frame extraction according to transmission parameters and for sending flag bits to server wrapper API (401) for speech recognition; a server wrapper API (401) for interfacing between server wrapper (400) and outside modules; and a DSRML server transceiver (405) for sending DSRML documents and for receiving initial connection requests. The DSRML server transceiver (405) also includes a DSRML TCP server (406) for implementing the function of a TCP server.

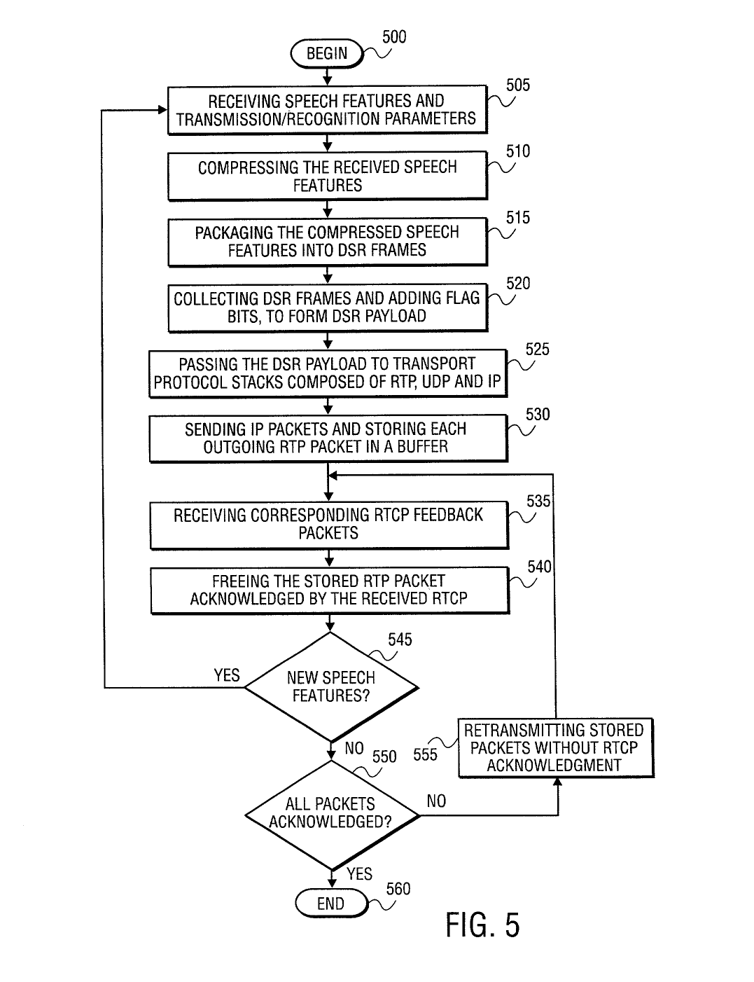

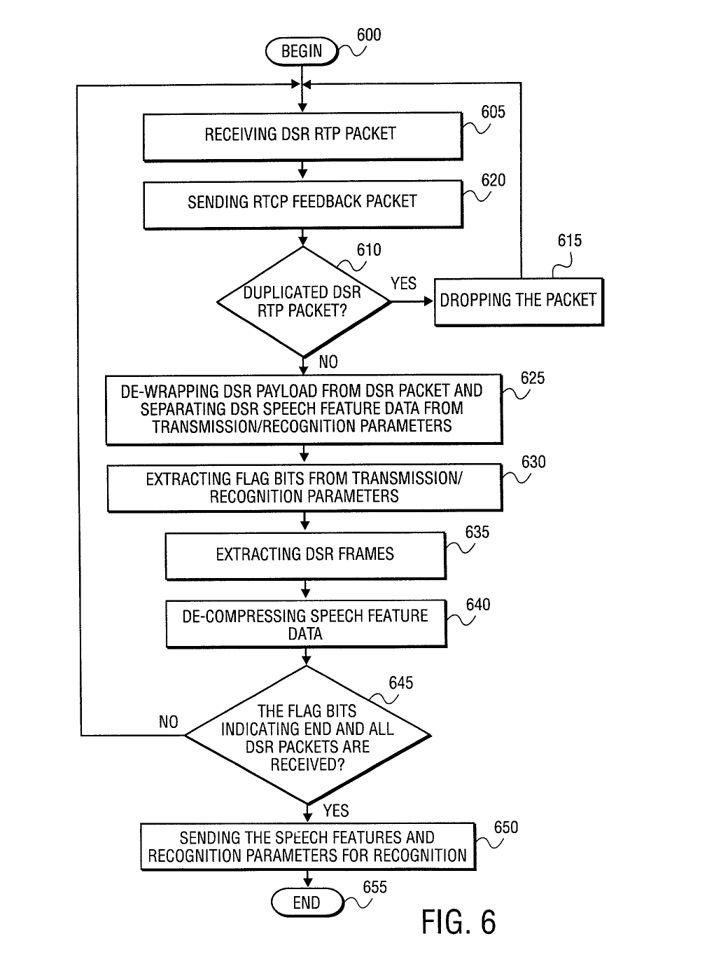

The processes involved in the data transmission of the DSR application system are illustrated by the following description with references to FIG. 5 and FIG. 6.

FIG. 5 is a flow chart that depicts a method for sending DSR data from the DSR client of a DSR application system, in accordance with one embodiment of the present invention. The process starts at block (505), where client wrapper API (301) receives speech features and transmission/recognition parameters from DSR client browser (211). At block (510), the received speech features are compressed by the feature compressor (302). Then, the compressed speech features are packaged into DSR frames by DSR frame constructor (303), at block (515). The DSR frames and flag bits in the transmission/recognition parameters are collected by DSR payload wrapper (304) at block (520), to form the DSR payload. Preferably, the DSR payload should contain the maximum number of DSR frames that the underlying transport protocol can support.

Next at block (525), the DSR payload is passed to transport protocol stacks composed of RTP, UDP and IP. At block (530), IP packets are sent to the DSR server (203) and each outgoing RTP packet is stored in a buffer. While sending the RTP packets to the DSR server (203), the DSR client (201) also receives corresponding RTCP feedback packets concurrently, at block (535). At block (540), the stored RTP packets acknowledged by the received RTCP packets are freed.

Afterwards, at block (545), a determination is made to determine if: new speech features have been generated by the front-end engine (213) and sent to client wrapper API (301). If so, then repeat the process from block (505). If no new speech features have been generated, go on to block (550). Another determination is made at block (550) to determine if: all outgoing packets are acknowledged. If so, the process is ended at block (560); otherwise at block (555), stored packets that are not acknowledged by RTCP packets are retransmitted and then the process is repeated from block (535).

Because QoS support is an option of network operators and mobile users and because highly reliable transmission is required for DSR applications over GPRS, we use TCP with its enhancement for DSR speech feature data transfer if no QoS is provided across a particular network.

TCP ensures reliable end-to-end data delivery even when lower-layer services do not provide QoS guarantees. DSR data traffic in our application scenario is typically dominated by short burst transfers, which are spaced out by long idle periods while users are browsing the information. Short transfers and idle connection introduce much latency and degrade TCP performance for DSR transmission. In order to overcome these problems, in accordance with another embodiment of the present invention the following steps could be taken:

Increasing TCP initial window. Traditional TCP applies an initial window (IW) of an SMSS (sender maximum segment size) to transfer user data, which introduces much latency into DSR applications. Preferably, the TCP IW should be increased to twice the standard SMSS for DSR transmission, because this size reduces transfer latency significantly. It is true that with the augmentation of IW, packet drop rate also increases. But the increase in drop rate is less than 1% if IW is set to twice the standard segment size. Thus, the increase of TCP IW to twice the SMSS is worthwhile.

Adopting no slow-start restart. The behavior of existing TCP when restarting after an idle period (when users are browsing obtained information) can be characterized as either no slow-start restart (NSSR) or slow-start restart (SSR). In the former approach, the TCP sender may send a large burst of back-to-back packets reusing the prior congestion window upon restarting after an idle connection, which risks router buffer overflow and subsequent packet loss. In the latter case, TCP enters slow start and initializes the current sending window to the size of the initial window, leading to low throughput and long latency. Taking the characteristics of DSR bit streams into consideration, NSSR should be selected to send DSR speech feature data preferably, because the gap of 10 ms between two successive frames limits the burstness of short DSR flows to the data rate of approximately 4600 bit/s after an idle time, thus avoiding bursty back-to-back packet transmission.

Applying TCP SACK. TCP selective acknowledgment options (TCP SACK) are used as a means to alleviate TCP's inefficiency in handling multiple drops in a single window of data. Unlike the standard cumulative TCP ACKs, TCP SACK informs the sender of data that has been received so as to avoid retransmission of successfully delivered segments.

FIG. 6 is a flow chart that depicts a method for receiving DSR data at a DSR server of a DSR application system, in accordance with one embodiment of the present invention. The process starts at block (600), where a DSR RTP packet is received at block (605) and its corresponding RTCP acknowledgement packet is sent at block (620), as shown in FIG. 6. At block (610), a determination is made to identify whether the received packet is a duplicated DSR RTP packet because of a fast retransmission. If it is a duplicated packet, the packet is dropped at block (615) and the process repeats from block (605). Otherwise, at block (625), the DSR payload is de-wrapped from the DSR packet, and DSR speech feature data and transmission/recognition parameters are separated. Afterwards, at block (630), flag bits are extracted from the transmission/recognition parameters and at block (635), DSR frames are extracted. At block (640), speech feature data is de-compressed. Then, a determination is made at block (645) to determine whether the extracted flag bits indicate the end of speech. If the determination of block (645) is no, the process repeats from block (605). If the determination of block (645) is yes, the speech features and recognition parameters for recognition are sent to DSR server browser (231), and the process finishes at block (655).

Accordingly, if the DSR speech feature data is sent out through TCP/IP protocol stacks, the receiving process should include receiving TCP packets, sending back a TCP Selective Acknowledgement packet to the DSR client and the blocks (620) to (655) as shown in FIG. 6 in accordance with another embodiment of the present invention.

In the section above, a system and method of DSR data transmission for a DSR application over GPRS that can transmit DSR data reliably without large latency between DSR server and DSR clients is described. The scope of protection of the claims set forth below is not intended to be limited to the particulars described in connection with the detailed description of the presently described embodiments.

The present invention provides a DSR data transmission system for a DSR application over GPRS. The DSR application includes a plurality of DSR clients, each comprising a DSR client browser and a front-end engine, a DSR server comprising a DSR server browser and a DSR recognition-engine, and a Web server. The DSR data transmission system comprises a client wrapper for sending connection requests, receiving DSRML content, transmitting speech feature data and handling events for synchronization; a client protocol stack for supporting standard underlying communication protocols; a wireless/wired gateway for supporting wireless and wired communication between DSR clients and the DSR server; a server wrapper for receiving speech feature data, transmitting and wrapping DSRML content and handling events for synchronization; and a server protocol stack for supporting standard underlying communication protocols.

The present invention also provides a DSR client of a DSR application comprising a DSR client browser for allocating the tasks, displaying content and originating QoS requests; a front-end engine for reducing noise, extracting speech features; a client protocol stack for supporting standard underlying communication protocols; and a DSR client wrapper for sending connection requests, receiving DSRML content, transmitting speech feature data and handling events for synchronization.

The present invention also provides a DSR server of a DSR application comprising: a DSR server browser for interpreting DSRML documents, allocating the tasks, sending display content back to a DSR client and originating QoS requests; a server wrapper for receiving speech feature data, transmitting and wrapping DSRML content and handling events for synchronization; and a server protocol stack for supporting standard underlying communication protocols.

Thus, a DSR data transmission system and method is described.

What is claimed is:

1. A DSR system comprising:
a client to send connection requests, receive displayable content, and transmit speech feature data to a server;
a gateway coupled between the client and the server to support data communication between the client and the server; and
a server to receive the speech feature data, perform speech recognition on the speech feature data, and transmit displayable content to the client.

2. A DSR system in accordance with claim 1, wherein said client further includes:
a client wrapper API to interface with a DSR client browser;
a DSR frame constructor coupled to the client wrapper API to construct DSR frames;
a DSR payload wrapper coupled to the DSR frame constructor to construct DSR payload packets from the DSR frames; and
a DSRML client transceiver to receive displayable content and to send an initial connection request to the server.

3. A DSR system in accordance with claim 2, wherein said client further includes:
a client transmission/recognition adapter to adjust transmission control conditions of the DSR payload wrapper and to control flag bits needed for speech recognition according to transmission/recognition parameters; and
said DSR payload wrapper to add flag bits to the DSR payload packets.

4. A DSR system in accordance with claim 1, wherein said client further includes:
a client protocol stack having a TCP module supporting TCP protocol and an IP module supporting IP protocol.

5. A DSR system in accordance with claim 4, wherein said client protocol stack further includes a UDP module to support UDP protocol, the client further including:
an RTP sender to send data using RTP through UDP/IP protocol stacks, said RTP sender including a buffer to store data packets having been sent out but not acknowledged by the server;
said RTP sender re-transmitting the stored packets that are not acknowledged by corresponding RTCP packets till all DSR RTP outgoing packets are acknowledged; and
said DSR payload wrapper passing the DSR payload packet to corresponding protocol stacks according to TCP/UDP selection in a set of transmission/recognition parameters.

6. A DSR system in accordance with claim 2, wherein said client further includes:
a feature compressor coupled to the client wrapper API and the DSR frame constructor to compress speech feature data.

7. A DSR system in accordance with claim 1, wherein said server further includes:
a DSR payload de-wrapper to separate DSR speech feature data from transmission/recognition parameters;
a DSR frame extractor coupled to the DSR payload de-wrapper to extract DSR frames;
a server wrapper API coupled to the DSR frame extractor to interface with a DSR server browser; and
a DSRML server transceiver to send displayable content and to receive an initial connection request from the client.

8. A DSR system in accordance with claim 7, wherein said server further includes a server stack having a UDP module to support UDP protocol, the server further including:
an RTP receiver to receive DSR payload packets using RTP through UDP/IP protocol stacks and extracting DSR payload from the DSR payload packets; and
a server transmission/recognition adapter coupled to the DSR payload de-wrapper and the DSR frame extractor to control frame extraction according to transmission parameters and flag bits for speech recognition.

9. A DSR system in accordance with claim 8, wherein said server further includes:
a frame de-compressor coupled to the server wrapper API to de-compress speech feature data.

10. A DSR system in accordance with claim 1 wherein said gateway supports wireless data communication.

11. A DSR system in accordance with claim 1 wherein said gateway supports wired data communication.

12. The DSR system in accordance with claim 1 further including a Web server coupled to the server via a network.

13. The DSR system of claim 1 wherein the client further includes:
a front-end engine for reducing noise and to extract the speed feature data.

14. The DSR system of claim 1 wherein the displayable content is represented as a DSRML document.

15. A method comprising:
receiving input speech data;
extracting speech features from the input speech data;
packaging the speech features into DSR frames in a DSR frame format;
collecting DSR frames to form a DSR payload; and
transmitting the DSR payload to a server for speech recognition processing.

16. The method of claim 15 further including:
increasing a TCP initial window;
adopting no slow-start restart;
applying TCP SACK; and
passing the DSR payload to a transport protocol stack composed of TCP and IP.

17. A method comprising:
receiving a DSR payload packet;
de-wrapping DSR payload from the DSR payload packet and separating DSR speech feature data from transmission/recognition parameters;
extracting DSR frames from the DSR payload;
extracting speech feature data from the DSR frames; and
sending the speech feature data to a speech recognition engine and for recognition.

18. The method of claim 17 further including de-compressing the speech feature data.

19. A machine-readable medium having stored thereon executable code which causes a machine to perform a method for transmitting DSR data, the method comprising:
receiving input speech feature data;
extracting speech features from the input speech data;
packaging the speech features into DSR frames in a DSR frame format;
collecting DSR frames to form a DSR payload; and
transmitting the DSR payload to a server for speech recognition processing.

20. A machine-readable medium in accordance with claim 19, further comprising:
increasing a TCP initial window;
adopting no slow-start restart;
applying TCP SACK; and
passing the DSR payload to a transport protocol stack composed of TCP and IP.

21. A machine-readable medium having stored thereon executable code which causes a machine to perform a method for receiving DSR data, the method comprising:
receiving a DSR payload packet;
de-wrapping DSR payload from the DSR payload packet and separating DSR speech feature data from transmission/recognition parameters;
extracting DSR frames from the DSR payload;
extracting speech feature data from the DSR frames; and
sending the speech feature data to a speech recognition engine for recognition.

22. A machine-readable medium in accordance with claim 21, further including decompressing the speech feature data.
